(19) United States
(12) Patent Application Publication
(10) Pub. No.: US 2026/0282009 A1
(43) Pub. Date: Sep. 17, 2026

(54) METHOD AND DEVICE FOR SUPPORTING UPLINK SCHEDULING IN CONSIDERATION OF TRANSMISSION DELAY OF TETHERED DEVICE

(71) Applicant: Samsung Electronics Co., Ltd., Gyeonggi-do (KR)

(72) Inventors: Jaehyeon BAE, Gyeonggi-do (KR); Jicheol LEE, Gyeonggi-do (KR)

(21) Appl. No.: 19/472,930

(22) PCT Filed: Apr. 5, 2024
(86) PCT No.: PCT/KR2024/004491

§ 371 Date: Oct. 6, 2025

(30) Foreign Application Priority Data
Apr. 6, 2023 (KR) 10-2023-0045683

(51) Int. Cl. H04W 72/1268; H04L 41/0894; H04L 47/283

(52) U.S. Cl. CPC H04W 72/1268; H04L 41/0894; H04L 47/283

(57) ABSTRACT

The present disclosure relates to a 5G or 6G communication system for supporting higher data transmission rates. The present disclosure provides a method of a session management function (SMF) entity for supporting uplink scheduling of a terminal using a tethered device, the method comprising the operations of: receiving a protocol data unit (PDU) session-related session management (SM) message including at least one of a tethered device support indicator and tethered device jitter information from an access management function (AMF) entity; and in response to the PDU session-related SM message, transmitting N2 SM information including at least one of the tethered device support indicator and the tethered device jitter information to an access node (AN) through the AMF entity.

### TECHNICAL FIELD

The disclosure relates to a method and a device for supporting scheduling of an uplink packet by consideration of transmission delay of a tethered device wiredly/wirelessly connected to a UE in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing. and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication,

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, in order to promote evolution from the conventional 4G LTE system to the 5G system, 3GPP in charge of cellular mobile communication standards has named a new core network structure as a 5G core (5GC) and standardized it.

5GC supports the following differentiated functions compared to an evolved packet core (EPC) that is a network core for the 4G.

First, a network slice function is introduced in the 5GC. In requirements of the 5G, the SGC should support various UE types and services (e.g., enhanced mobile broadband (eMBB), ultra reliable low latency communications (URLLC), or massive machine type communications (mMTC)). The UEs/services have different requirements for the core network. For example, the eMBB service requires a high data rate, and the URLLC service requires high stability and low latency. A technology proposed to meet such various service requirements is the network slice scheme.

The network slice is a method of virtualizing one physical network to generate several logical networks, and network slice instances (NSIs) may have different characteristics. Every NSI may have a network function (NF) suitable for the characteristic and thus meet various service requirements. Various 5G services may be efficiently supported by allocating the NSI suitable for the service characteristic required for each UE.

Second, the 5GC may easily support a network virtualization paradigm through separation of a mobility management function and a session management function. In the 4G LTE, all UEs may receive services over the network through a signaling exchange with a single core equipment that is a mobility management entity (MME) in charge of registration, authentication, mobility management, and session management functions. When the single equipment such as the MME supports all functions as the number of UEs explosively increases and mobility and traffic/session characteristics, which should be supported according to the UE type, are subdivided in the 5G, scalability for adding entities according to each of required functions cannot help being reduced. Accordingly, various functions are developed based on a structure of dividing a mobility management function and a session management function in order to improve a function/implementation complexity of a core equipment serving a control plane and expandability in the light of signaling load.

### DETAILED DESCRIPTION OF THE INVENTION

### Technical Problem

In the case of metaverse and extended reality (XR) applications, the UE should transmit and receive various types of media information (video, audio, haptic, text, or the like) and transmit the same to a tethered device in the connection form of non-3GPP connection type (Wi-Fi, Bluetooth, or the like). At this time, in order to effectively process traffic, an important technical problem should be solved unlike the existing application of transmitting/receiving data by a single UE.

Unlike previous studies that have mainly focused on effectively transmitting downlink traffic to the UE, metaverse/XR traffic needs to effectively handle uplink traffic generated from a wired/wirelessly connected tethered device in consideration of service characteristics for each packet depending on a user's selection. Further, an XR device requires a large amount of traffic processing, but may need scheduling of uplink data considering a transmission delay time of an additional tethered device when a service considering the tethered device is used to efficiently manage power of the device for increasing the service usage time in consideration of the limited battery capacity of the device when the XR service is used.

### Technical Solution

According to an embodiment of the disclosure, an apparatus and a method for supporting uplink data scheduling in consideration of a transmission delay time of a tethered device connected to a UE in a communication system may be provided.

According to an embodiment of the disclosure, an apparatus and a method may be provided in which a UE measures transmission delay information with a tethered device connected to the UE, based on a statistical characteristic, and provides relevant information for an uplink data scheduling service, based on network and service characteristic information provided by an application server or a function entity.

According to an embodiment of the disclosure, a method of a session management function (SMF) entity supporting uplink scheduling of a UE using a tethered device includes receiving, from an access management function (AMF) entity, a protocol data unit (PDU) session-related session management (SM) message including at least one of a tethered device support indication and tethered device jitter information and in response to the PDU session-related SM message transmitting, to an access node (AN) through the AMF entity, N2 SM information including at least one of the tethered device support indication and the tethered device jitter information.

According to an embodiment of the disclosure, a method of an access management function (AMF) entity supporting uplink scheduling of a UE using a tethered device includes transmitting, to a session management function (SMF) entity, a protocol data unit (PDU) session-related session management (SM) message including at least one of a tethered device support indication and tethered device jitter information, in response to the PDU session-related SM message receiving, from the SMF entity, N2 SM information including at least one of the tethered device support indication and the tethered device jitter information, and transmitting, to an access node (AN), the N2 SM information.

According to an embodiment of the disclosure, a session management function (SMF) entity supporting uplink scheduling of a UE using a tethered device includes a transceiver and a processor configured to receive, from an access management function (AMF) entity, a protocol data unit (PDU) session-related session management (SM) message including at least one of a tethered device support indication and tethered device jitter information by controlling the transceiver and in response to the PDU session-related SM message transmit, to an access node (AN) through the AMF entity, N2 SM information including at least one of the tethered device support indication and the tethered device jitter information.

According to an embodiment of the disclosure, an access management function (AMF) entity supporting uplink scheduling of a UE using a tethered device may include a transceiver and a processor configured to control the transceiver to transmit. to a session management function (SMF) entity, a protocol data unit (PDU) session-related session management (SM) message including at least one of a tethered device support indication and tethered device jitter information, in response to the PDU session-related SM message receive, from the SMF entity, N2 SM information including at least one of the tethered device support indication and the tethered device jitter information, and transmit, to an access node (AN), the N2 SM information.

According to an embodiment of the disclosure, an apparatus and a method for, when transmission delay of jitter or the like is generated by a network environment between a UE and a tethered device connected to the UE in a communication system. transferring jitter range information of the network between the UE and the tethered device connected to the UE measured through the process to a radio access network (RAN) (for example, a base station) and supporting a scheduling operation of packets for power saving in consideration of a characteristic (for example, discontinuous reception (DRX) parameters) of a power-saving service transmitted from the UE may be provided.

According to an embodiment of the disclosure, a method of operating a session management function (SMF) in a wireless communication system may include receiving jitter information including a jitter range of the network between the UE and the tethered device connected to the UE transmitted from the user equipment (UE) through an access management function (AMF) and transmitting network delay information including the jitter range to a radio access network (RAN).

According to an embodiment of the disclosure, a method of operating a policy control function (PCF) in a wireless communication system may include receiving, when tethered device-related network delay information is transmitted from the UE, the same from a session management function (SMF), based on a policy control request trigger (PCRT) in order to receive network delay information including a jitter range of the network between the UE and the tethered device connected to the UE from the SMF to support uplink data of the tethered device transmitted from the user equipment (UE) and updating quality of service (QoS) of the corresponding service flow, based on the tethered device-related network delay information, and transmitting the updated policy & charging control (PCC) rule to the SMF.

According to an embodiment of the disclosure, a method of a session management function (SMF) in a wireless communication system may include receiving PCC rule information including new QoS information considering a jitter range of the network between the UE and the tethered device connected to the UE transmitted from the PCF, transmitting updated N4 rule information including a QoS configuration rule (QoS enforcement rule) of the updated service flow to the UPF, based on the updated rule, and transmitting updated QoS profile information to the RAN.

According to an embodiment of the disclosure, a method of operating a session management function (SMF) in a wireless communication system may include receiving a power-saving service support indication, uplink packet periodicity information (UL periodicity), a tethered device support indication, tethered device jitter information transmitted from the UE, receiving AF periodicity information through an application function (AF) or the power-saving service support indication and the uplink packet periodicity information (UL periodicity) through a network exposure function (NEF), transferring, when receiving the power-saving service support indication or the tethered device jitter information from the UE, the same to the PCF and receiving a policy and an updated charging control (PCC) rule, based on the corresponding information, and transmitting the tethered device jitter information to the next-generation (NG)-RAN through TSCAI or the like, based on the updated PCC rule for the power-saving service.

According to an embodiment of the disclosure, a policy control function (PCF) includes a transceiver and a controller in a wireless communication system. The controller may receive delay information of the network including a jitter range between a UE and a tethered device connected to the UE transmitted from the user equipment (UE) or an application function (AF) through an access management function (AMF) or a network exposure function (NEF). The controller may update a policy and charging control (PCC) rule including changed quality of service (QOS) information of the service flow considering the corresponding network delay information, based on delay information of the network including the jitter range between the UE and the tethered device connected to the UE. The controller may perform control to transmit the updated PCC rule to a session management function (SMF) in order to transfer QoS information of the updated service flow to a user plane function (UPF), based on the delay information of the network including the jitter range between the UE and the tethered device connected to the UE.

According to an embodiment of the disclosure, a session management function (SMF) includes a transceiver and a controller in a wireless communication system. The controller may receive delay information of the network including a jitter range between a UE and a tethered device connected to the UE transmitted from the user equipment (UE) through an access management function (AMF). The controller may transfer the delay information of the network to an RAN through time sensitive communication assistance information (TSCA) or the like. The controller may perform control to transmit PDU session modification command information including acceptance or rejection of the RAN for a protocol data unit (PDU) session establishment or modification request requested by the UE to the UE, based on the delay information of the network.

According to an embodiment of the disclosure, a user equipment (UE) includes a transceiver and a controller in a wireless communication system. The controller may receive data packets transmitted from the tethered device connected to the user equipment (UE), calculate the difference between the corresponding packets, and calculate network delay information including a jitter range or the like, based on a statistical characteristic of the difference between the corresponding packets. The controller may transfer the delay information of the network to a session management function (SMF) through a non-access-stratum (NAS) message. The controller may transfer the delay information of the network to the SMF through an application function (AF) connected to an application server by using separate signaling. The controller may control an operation of modifying the network connection to the tethered device after receiving PDU session modification command information including acceptance or rejection of the RAN for the PDU session establishment or modification request requested by the UE, based on the delay information of the network.

### Advantageous Effects

According to an embodiment of the disclosure, in order to perform an uplink packet scheduling operation by the RAN, the PCF may manage a policy for allowing a UE to transfer network delay information including jitter range information of a tethered device connected to the UE.

According to an embodiment, the UE may measure network delay information such as jitter information of the tethered device connected to the UE and transfer the same to the RAN, based on a statistical characteristic to perform uplink scheduling. According to an embodiment of the disclosure, the UE may measure network delay information such as jitter information of the tethered device connected to the UE, transfer a PDU session establishment or modification request based on statistical characteristic-based information to the RAN through the SMF, and then receive a result value of the corresponding PDU session establishment and modification request information through a PDU session modification command or the like. According to an embodiment of the disclosure, the UE may measure network delay information such as jitter information of the tethered device connected to the UE within the PDU session modification command, transfer the same to the RAN through a PDU session establishment or modification request based on the statistical characteristic information, reconfigure the connection of the tethered device through a change in the network type of the tethered device connected to the corresponding UE when the PDU session establishment or modification request is rejected, network delay information based on the reconfigured network to the RAN again through the PDU session establishment or modification request via the SMF, and then receive a result value of the corresponding connection request information from the RAN.

According to an embodiment of the disclosure, the UE may report network delay information including tethered device jitter information via the SMF through the PDU session establishment or modification request, and the RAN may change (update DRX parameters) service characteristics according to the network delay information such as the jitter information of the tethered device connected to the UE received through the reporting process.

According to an embodiment of the disclosure, in a high-frame rate (for example, 90 fps or 120 fps) and high-capacity application traffic service such as the XR service, the network between the UE and the tethered device connected to the UE may control service characteristics (DRX parameters), based on the packet transmission delay and jitter and provide an appropriate power-saving service function according to a network change. According to an embodiment of the disclosure, an apparatus and a method capable of providing an efficient XR service application service may be provided.

### BRIEF DESCRIPTION OF DRAWINGS

FIG. 1 illustrates a network structure and interfaces of a 5G system according to an embodiment of the disclosure.

FIG. 2 illustrates an example of measuring the delay deviation of packets from the AS at the UPF and applying the same through a DRX parameter update process in a downlink environment of the wireless communication system according to an embodiment of the disclosure.

FIG. 3 is a diagram illustrating an operation in which a UE transfers a network transmission delay value including a tethered jitter information value of a tethered device connected to the UE to a network in the wireless communication system according to an embodiment of the disclosure.

FIG. 4 is a diagram illustrating the operation in which the UE transfers the network transmission delay value including the tethered jitter information value of the tethered device connected to the UE to the network and a policy determination process indicating whether to update the service flow QoS, based on the corresponding information in the wireless communication system according to an embodiment of the disclosure.

FIG. 5 is a diagram illustrating the operation in which the UE transfers the network transmission delay value including the tethered jitter information value of the tethered device connected to the UE to the network and a DRX parameter transmission process for a power saving service, based on the corresponding information in the wireless communication system according to an embodiment of the disclosure.

FIGS. 6A and 6B are flowcharts illustrating an operation in which the UE transfers a packet transmission delay value of a tethered device connected to the UE to the network and then the network accepts or rejects a PDU session modification request of the corresponding service flow in the wireless communication system according to an embodiment of the disclosure.

FIGS. 7A and 7B are flowcharts illustrating the operation in which the UE transfers the network transmission delay value including the tethered jitter information value of the tethered device connected to the UE to the network and the policy determination process indicating whether to update the service flow QoS, based on the corresponding information in the wireless communication system according to an embodiment of the disclosure.

FIGS. 8A and 8B are flowcharts illustrating a process in which the UE transfers the packet transmission delay value of the tethered device connected to the UE to the network and then updates a DRX parameter, based on the same, in the wireless communication system according to another embodiment of the disclosure.

FIG. 9 is a diagram illustrating a method of an SMF entity supporting uplink scheduling of the UE using a tethered device according the disclosure.

FIG. 10 is a diagram illustrating a method of an AMF entity supporting uplink scheduling of the UE using a tethered device according the disclosure.

FIG. 11 illustrates a device structure of a network entity according to the disclosure.

FIG. 12 illustrates a device structure of a UE according to the disclosure.

### MODE FOR CARRYING OUT THE INVENTION

Hereinafter, an embodiment of the disclosure will be described in detail with reference to the accompanying drawings.

In describing the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B (or xNode B (where, x is an alphabet including g or e)), a wireless access unit, a base station controller, a satellite, an airborne, and a node on a network. A user equipment (UE) may include a mobile station (MS), a vehicular, a satellite, an airborne, a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Additionally, a “sidelink (SL)” may exist, which refers to a radio link via which a UE transmits a signal to another UE.

Furthermore, in the following description, LTE or LTE-A systems may be described by way of example, but the embodiments of the disclosure may also be applied to other communication systems having similar technical backgrounds or channel types. For example, 5G-Advance, NR-Advance, or 6th generation (6G) mobile communication technologies developed beyond 5G mobile communication technologies (or new radio (NR)) may be included therein, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a UE transmits data or control signals to a base station, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, cMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

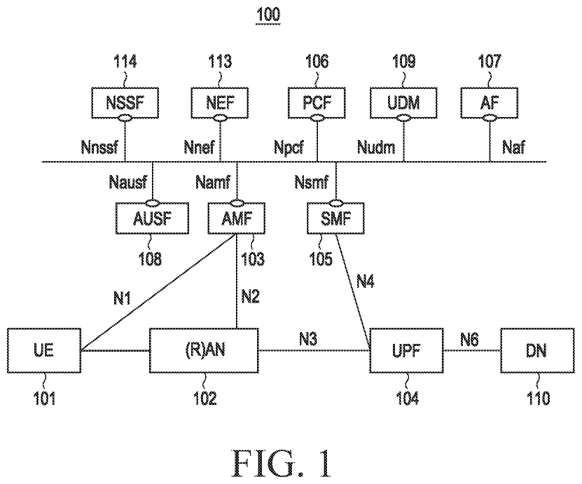

FIG. 1 illustrates a network structure and interfaces of a 5G system according to an embodiment of the disclosure.

Network entities included in the network structure of the 5G system in FIG. 1 may include network functions (NFs), depending on system implementations.

Referring to FIG. 1, the network structure of the 5G system 100 may include at least one of various network entities. For example, the 5G system may include at least one of an authentication server function (AUSF) entity 108, an access and mobility management function (AMF) entity 103, a session management function (SMF) entity 105, a policy control function (PCF) entity 106, an application function (AF) entity 107, a unified data management (UDM) entity 109, a data network (DN) entity 110, a network exposure function (NEF) entity 113, a network slicing selection function (NSSF) entity 114, an edge application service domain repository (EDR), an edge application server (EAS), an EAS discovery function (EASDF), a user plane function (UPF) entity 104, a (radio) access network (R)AN) 102, and a terminal. for example, a user equipment (UE) 101.

The respective NFs of the 5G system 100 may support the following functions.

The ASUF 108 may process and store data for authentication of the UE 101.

The AMF 103 may provide a function for access and mobility management on a per-UE basis, and basically, one UE may be connected to one AMF. Specifically, the AMF 103 may support functions such as signaling between CN nodes for mobility between 3GPP access networks, radio access network (RAN) CP interface (i.e., N2 interface) termination, non-access stratum (NAS) signaling termination (N1), NAS signaling security (NAS ciphering and integrity protection), AS security control, registration management (registration area management), connection management, idle mode UE reachability (including control and execution of paging retransmission), mobility management control (subscription and policy), intra-system mobility and inter-system mobility support, network slicing support, SMF selection, lawful intercept (LI) (for an AMF event and an interface to an LI system), delivery of session management (SM) messages between the UE and the SMF, a transparent proxy for session management (SM) message routing, access authentication, access authorization including roaming permission checking, delivery of SMS messages between the UE and a short message service function (SMSF), a security anchor function (SAF), and/or security context management (SCM). Some or all of the functions of the AMF 103 may be supported within a single instance of one AMF.

The DN 110 refers to, for example, an operator service, Internet access, a third-party service, or the like. The DN 110 may transmit a downlink protocol data unit (PDU) to the UPF 104, or receive, from the UPF 104, a PDU transmitted by the UE 101.

The PCF 106 may provide a function of receiving information on a packet flow from an application server to determine policies, such as mobility management and session management. Specifically, the PCF 106 may support functions, such as support of a unified policy framework for controlling a network operation, provision of a policy rule so that the control plane function(s) (e.g., AMF, SMF, etc.) may execute the policy rule, and front end implementation for accessing related subscription information in order to determine a policy within a user data repository (UDR).

The SMF 105 may provide a session management function, and if the UE 101 bas multiple sessions, each session may be managed by a different SMF. Specifically, the SMF 105 may support functions such as session management (e.g., establishment, modification, and release of a session, including maintenance of a tunnel between the UPF 104 and the (R)AN 102 node), UE Internet protocol (IP) address assignment and management (optionally including authentication), UP function selection and control, configuration of traffic steering to route traffic from the UPF 104 to an appropriate destination, and termination of interfaces toward policy control functions, enforcement of policy and quality of service (QOS) control parts, lawful intercept (LI) (for an SM event and an interface to an LI system), termination of NAS message SM parts, downlink data notification, delivery of access network (AN)-specific SM information to (R)AN 102 through N2 via an initiator (AMF 103), determination of a session and service continuity (SSC) mode, and a roaming function. Some or all of the functions of the SMF 105 may be supported within a single instance of one SMF.

The UDM 109 may store the user's subscription data, policy data, and the like. The UDM 109 may include two parts, that is, an application front end (FE) (not illustrated) and a user data repository (UDR) (not illustrated).

The FE may include a UDM FE responsible for location management, subscription management, credential processing, etc., and a PCF entity responsible for policy control. The UDR may store data required for functions provided by the UDM-FE and a policy profile required by the PCF. Data stored in the UDR may include policy data and user subscription data including a subscription identifier, security credential, access and mobility-related subscription data, and session-related subscription data The UDM-FE may support functions, such as access to subscription information stored in the UDR, authentication credential processing, user identification handling, access authentication, registration/mobility management, subscription management, and SMS management.

The UPF 104 may transfer a downlink PDU, received from the DN 110, to the UE 101 via the (R)AN 102 and transfer an uplink PDU, received from the UE 101, to the DN 110 via the (R)AN 102. Specifically, the UPF 104 may support functions such as an anchor point for intra-/inter-RAT mobility, an external PDU session point for interconnection to a data network, packet routing and forwarding, a user plane part of packet inspection and policy rule enforcement, lawful intercept, and traffic usage reporting, uplink classifier for supporting the routing of traffic flows to the data network, branching points for supporting multi-homed PDU sessions, QoS handling for a user plane (e.g., packet filtering, gating, uplink/downlink rate enforcement), uplink traffic verification (SDF mapping between service data flow (SDF) and QoS flow). transport-level packet marking within uplink and downlink, downlink packet buffering, and downlink data notification triggering. Some or all of the functions of the UPF 104 may be supported within a single instance of one UPF.

The AF 107 may interwork with a 3GPP core network in order to provide services (e.g., supporting functions, such as an application influence on traffic routing, access to network capability exposure, and interworking with a policy framework for policy control).

The (R)AN 102 collectively refers to a new radio access network capable of supporting both evolved E-UTRA which is an evolved version of 4th generation (4G) radio access technology and new radio (NR) technology (e.g., gNB).

The gNB may support functions, such as functions for radio resource management (i.e., radio bearer control, radio admission control, connection mobility control, and dynamic allocation of resources (i.e., scheduling) to the UE in an uplink/downlink), Internet protocol (IP) header compression, encryption and integrity protection of a user data stream, selection of the AMF upon attachment of the UE when routing to the AMF has not been determined based on information provided to the UE, user plane data routing to the UPF(s), control plane information routing to the AMF, connection setup and release, paging message scheduling and transmission (generated from the AMF), system broadcast information scheduling and transmission (generated from the AMF or operation and maintenance (O&M)), measurement and measurement report configuration for mobility and scheduling, transport level packet marking in the uplink, session management, support of network slicing, QoS flow management and mapping to a data radio bearer, support of the UE that is in an inactive mode, a distribution function of a NAS message, a NAS node selection function, radio access network sharing, dual connectivity, and tight interworking between the NR and the E-UTRA.

The UE 101 refers to a user equipment. A user equipment may be referred to as such a term as “terminal”, “mobile equipment (ME)”, or “mobile station (MS)”. In addition, the user equipment may be a portable device, such as a laptop, a mobile phone, a personal digital assistant (PDA), a smartphone, or a multimedia device, or may be a non-portable device, such as a personal computer (PC) or a vehicle-mounted device.

The NEF Ill may provide means, provided by 3GPP network functions, for securely exposing services and capabilities for, for example, third parties, internal exposure/re-exposure, application functions, and edge computing. The NEF 111 receives information (based on the exposed capability (capabilities) of (an)other NF(s)) from the other NF(s). The NEF 111 may store the received information as structured data by using a standardized interface to a data storage network function. The stored information may be re-exposed by the NEF 111 to other NF(s) and AF(s) and used for other purposes such as analysis.

An EASDF is a network function (NF) capable of adding an EDNS client subnet (ECS) option that can be expressed as an address of a DNS server to which a domain name system (DNS) request from the UE is forwarded for each fully qualified domain name (FQDN) or an IP subnet address which should be added when the DNS request from the UE is forwarded. The EASDF receives EAS domain configuration information from an EDR and processes a DNS request message received from the UE according to the received information. Further, the EASDF may perform a function of receiving a UE IP address, location information of the UE within the 3GPP, a DNS message processing rule, and a DNS message report rule from the SMF 105, processing a DNS query message received from the UE or a DNS response message received from a DNS server, and transmitting information within the DNS message and statistical information obtained by processing the same to the SMF 105 according to the DNS message report rule.

Although an NF repository function (NRF) is not illustrated in FIG. 1 for clarity of description, other NFs may perform a mutual operation with the NRF as necessary.

The NRF 115 may support a service discovery function. The NRF 115 may receive an NF discovery request from an NF instance, and provide information on a discovered NF instance to the NF instance. In addition, the NEF 115 may maintain available NF instances and services supported by the available NF instances.

For the sake of descriptive convenience, FIG. I illustrates a reference model for a case where the UE 101 accesses one DN 110 by using one PDU session, but the disclosure is not limited thereto.

The UE 101 may concurrently access, for example, two (i.e., local and central) data networks by using multiple PDU sessions. In this case, two SMFs may be selected for different PDU sessions. However, each SMF may have the capability to control both a local UPF and a central UPF within a PDU session.

In addition, the UE 101 may concurrently access, for example, two (i.e., local and central) data networks provided within a single PDU session.

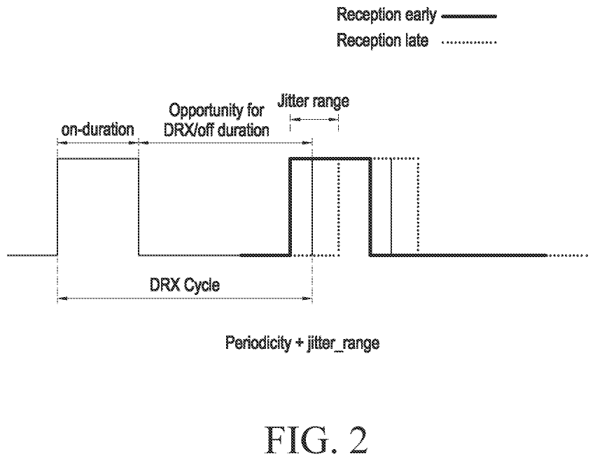

In 3GPP systems, conceptual links connecting NFs in the 5G system are defined as reference points. As an example, reference points included in the 5G system 100 of FIG. 1 are as follows.
N1: A reference point between a UE 101 and an AMF 103
N2: A reference point between an (R)AN 102 and an AMF 103
N3: A reference point between an (R)AN 102 and a UPF 104
N4: A reference point between an SMF 105 and a UPF 104
N5: A reference point between a PCF 106 and an AF 107
N6: A reference point between a UPF 104 and a DN 110
N7: A reference point between an SMF 105 and a PCF 106
N8: A reference point between a UDM 109 and an AMF 103
N10: A reference point between a UDM 109 and an SMF 105
N11: A reference point between an AMF 103 and an SMF 105
N12: A reference point between an AMF 103 and an AUSF 108
N13: A reference point between a UDM 109 and an AUSF 108
N14: A reference point between two AMFs 103
N15: A reference point between a PCF and an AMF for a non-roaming scenario, and a reference point between a PCF and an AMF in a visited network for a roaming scenario FIG. 2 illustrates a policy and operation of measuring, at the UPF, the packet delay variation in an N6 section from the AS through QoS monitoring in the conventional wireless communication system.

Referring to FIG. 2, it may be assumed that a 5G network and a terminal (or UE) is configured to support a UE power saving function using at least one piece of DRX-related information.

In FIG. 2, the UE may know that a packet will be periodically transmitted based on information (for example, at least one DRX parameter) included in a radio resource control (RRC) connection configuration.

The UE may operate with a DRX cycle, and the corresponding DRX cycle may have a long or short cycle value. When the UE starts reception of a packet such as a physical downlink control channel (PDCCH) and a period for receiving the corresponding packet is transferred to the UE as an on-duration parameter, the UE may enter a wake up mode during the on-duration after receiving the corresponding packet, and receive the packet. When the UE starts receiving the packet, information on how long the UE operates in the wake up mode using a timer may be transferred to the UE through a DRX parameter.

When the corresponding timer or on-duration time ends, the UE may enter a sleep mode to reduce battery consumption of the UE. A DRX parameter indicating the sleep mode may be expressed as an opportunity for DRX or off-duration as illustrated in FIG. 2A, and a period obtained by excluding a value of onDuration Timer from the DRX cycle value among DRX parameter values may be calculated.

In order to reduce battery consumption of the UE, parameters that define an operation cycle of the UE (wake-up and sleep mode) may be transmitted and received at the beginning of the connection through an RRC connection configuration message between the UE and the RAN. Thereafter, when the parameter value defining the operation cycle of the UE is updated, the updated value may be transferred to the UE through an RRC connection reconfiguration message, DRX parameter values configured in the corresponding UE may be updated again, and a packet transmission and reception operation cycle for saving the battery of the UE may be configured based on the corresponding updated parameter.

However, according to the actual network situation, the packet may be received by the UE earlier than the periodic operation cycle (a packet reception pattern indicated as “reception early” in FIG. 2A) or may be received by the UE later than the periodic operation cycle (a packet reception pattern indicated as “reception late” in FIG. 2A).

When the UE receives the packet according to the packet reception pattern indicated as “reception late”, the cycle to the pattern of the sleep mode of the UE may become shorter and efficiency may deteriorate.

When the UE receives the packet according to the packet reception pattern indicated as “reception early”, the wake-up cycle of the UE for the packet reception operation may become earlier than an operation prediction cycle (DRX cycle) within the DRX parameter previously received by the RAN, and when the UE switches from the sleep mode to the wake up mode before the DRX cycle, a prediction error in the operation pattern for battery efficiency of the UE may occur due thereto, and an efficient battery saving operation may not be performed.

When the UE repeatedly receives the packet according to the packet reception pattern indicated as “reception early”, the UE or the RAN may have difficulty in determining whether to perform the periodic operation using DRX parameters such as determining when the UE switches to the sleep mode or whether the current DRX cycle is wrong.

The UPF may measure jitter-related information generated during N6 section transmission and define, as a jitter range, a pattern of the packet arriving at the UE early or late by using the measured jitter-related information. As described above, the existing jitter information was used as a jitter range that controls the time at which monitoring of the corresponding periodic pattern starts based on the periodic information of the packet when the power saving service is used.

However, for uplink scheduling considering a tethered device connected to the UE, it may be difficult to perform an uplink packet scheduling operation through only range information of the arriving time based on the periodic information.

Accordingly, in order to provide scheduling considering the connection between the UE and the tethered device, the RAN of the wireless communication system according to an embodiment of the disclosure may determine a packet scheduling priority in consideration of an access network (AN) packet delay budget (PDB) that is transmission delay between the UE and the RAN, based on the PDB of the corresponding service flow of the UE and the packet delay budget for each of the remaining service flows, based on statistical characteristic information of the network between the tethered device connected to the UE and the UE. The remaining PDBs for each service flow used for determining the uplink packet scheduling priority may be defined as [Equation 1] below.

[Equation 1] is an example of measuring packet transmission delay values between the tethered device connected to the UE and the UE for packet scheduling and applying the same to the packet scheduling, based on the corresponding information in the wireless communication system according to an embodiment of the disclosure.

PDB−(AN PDB+(Mean tethered device PDB+Max_jitter_value)) (1)

The PDB denotes a PDB of the corresponding service flow, the AN PDB denotes a PDB between the UE and the AN, and the mean tethered device PDB denotes a PDB mean between the UE and the tethered device. Max_jitter_value is a maximum jigger value that can be determined as a different value depending on target packet loss. The target packet loss may be expressed as, for example, a percentage value, such as P95 corresponding to 95 percents, P99 corresponding to 99 percents, and P99.9 corresponding to 99.9 percents.

In order to consider network transmission delay between the tethered device connected to the UE and the UE, the UE may periodically measure transmission delay values of packets, calculate a packet delay change during the corresponding period, based on the mean of transmission delay values of the packets during the predetermined period, and generate tethered jitter information, based thereon. Further, in order to select a packet jitter range value considering packet loss of the service flow or the like, the UE may transfer statistical information of the packets arriving at the corresponding jitter range to the RAN and determine jitter range selection for each appropriate service flow when making the jigger information. The transferred statistical information may be information indicating the percent or may be a jitter range value corresponding to the indicated percent.

For example, when the H.323-based video conference service flow is used, in the case of the video service flow, if it is assumed that packet loss of 2% or higher is not allowed, the UE may configure jitter range values (P98, P99, and P99.9) making reception of packets of 98 percents or more possible within the corresponding jitter range when measuring the network transmission delay of the tethered device connected to the UE, include the jitter range values in tethered jitter information in the table form, transfer the tethered jitter information to the RAN, so as to determine selection of the appropriate jitter range (Max jitter value) for each service flow.

For example, in the case of the normal interactive voice service flow, in the case of the voice, and in the case of packet loss of 10⁻², the RAN receiving information of network jitter ranges of the tethered device connected to the UE as described above may select a jitter range value making reception of packets of 99 percents or more possible within the corresponding jitter range to perform packet scheduling when calculating a packet delay budget for packet scheduling considering the corresponding jitter.

Unlike the method of transmitting only inter-packet delay change value information of packets that do not arrive on the corresponding periodicity, based on the periodic information of FIG. 2 and applying the same to a DRX cycle, the UE may include a packet transmission change of the tethered device wiredly/wirelessly connected to the UE, a mean value of the packet transmission change, and values of jitter ranges in which data of predetermined percents or higher is received in network delay information and transfer the network delay information to the RAN, and the RAN may perform packet scheduling, based on the same in the disclosure. In the existing method, a value of the inter-packet delay change was small since only the jitter information of a wired section was calculated, but in the case of the tethered device wirelessly connected to the UE, a value of an additional delay change is large depending on the strength of a network signal, movement of the UE, a surrounding environment, or the like, so the value of the packet delay change of the actual corresponding section becomes large and the delay of the wirelessly connected tethered device is not negligible. Accordingly, in consideration of the packet delay change of the wireless tethered section, it is preferable to consider a jitter range selection process considering whether to accept the corresponding PDU session modification request and packet loss for each service flow.

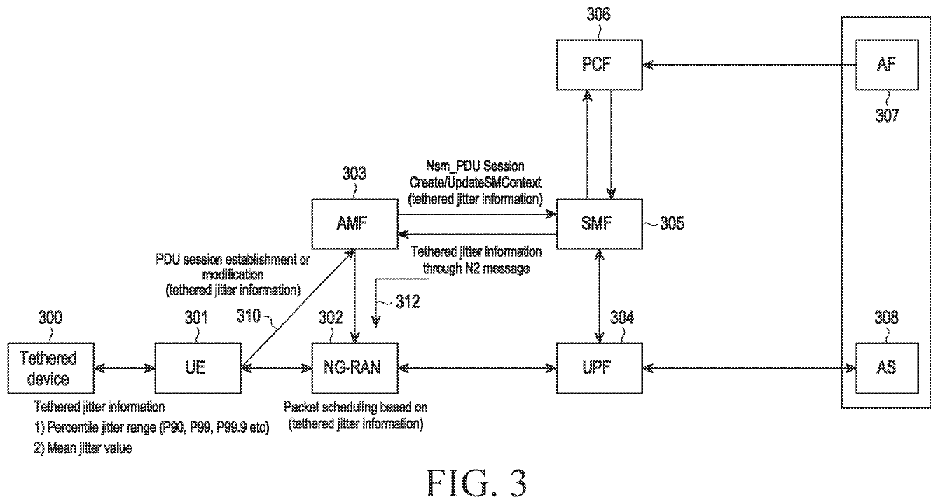

FIG. 3 is a diagram illustrating an operation in which a UE transfers a network transmission delay value including a tethered jitter information value of a tethered device connected to the UE to a network in a wireless communication system according to an embodiment of the disclosure.

Referring to FIG. 3, the wireless communication system may include at least one of a UE 301, an NG-RAN 302, an AMF 303, a UPF 304, an SMF 305, a PCF 306, an AF 307, or an application server (AS) 308.

The UE 301 may measure packet transmission delay information between the UE and the tethered device 300 connected to the UE, calculate the same, based on a statistical characteristic to generate tethered jitter information, and transfer the tethered jitter information to the SMF 305 in order to make a request for packet scheduling considering packet transmission of the corresponding tethered device. According to a configuration of a network operator, the UE 301 may directly transfer the tethered jitter information to the SMF 305 through a NAS message or transfer the tethered jitter information to the SMF 305 through AF session-related QoS requirement information by using the AF 307. The tethered jitter information may include at least one of a mean value of packet delay values between the tethered device 300 connected to the UE 301 and the UE 301 periodically measured during a predetermined time or a range value (P98, P99, P99.9, etc.) of a percentage-based delay change in which the corresponding packets are received.

Specifically, the range value of the percentage-based delay change in which the corresponding packets are received may indicate a rate at which packets transmitted from the tethered device 300 to the UE 301 are received based on packet loss of the corresponding service flow as shown in [Equation 11]. For example, when a value of the transmission delay change between the UE 301 and the tethered device 300 connected to the UE 301 is calculated as 99 percents (P99) based on a percentage-based jitter change value, the P99 may be a jitter range value of the statistical characteristic in which 99 percents of packets transmitted from the tethered device 300 to the UE 301 are successfully transmitted.

The UE 301 may transfer tethered jitter information considering the connection of the corresponding tethered device within a PDU session establishment or modification request message 310 to the SMF 305 through the AMF 303.

The SMF 305 receiving the tethered jitter information from the UE 301 may include at least one piece of the corresponding tethered jitter information and direction information of the corresponding connection in an N2 SM information message 312 and transmit the same to the NG-RAN 302 through the AMF 303 by using a time sensitive communication assistance information (TSCAI) container, a non-3GPP QoS assistance information container, a tethered device assistance information container, or the like. Alternatively, when the tethered jitter information for uplink packet scheduling is directly transferred from the NG-RAN 302 to the AMF 303 according to a policy of the network operator, the AMF 303 may directly transfer the tethered jitter information to the NG-RAN 302 without transferring the tethered jitter information to the SMF 305. In addition, when the number of tethered devices connected to the UE 301 is plural, the SMF 305 may include at least one piece of information (e.g. a differentiated services code point (DSCP) value of the tethered device) for distinguishing each tethered device and information on the QoS flow associated with the tethered device in QoS rule information or the like and transfer the same to the UE 301 through the NG-RAN 302. The UE 301 receiving at least one piece of the information (e.g. the DSCP value of the tethered device) for distinguishing the tethered devices and the information on the QoS flow associated with the tethered devices through the QoS rule information may distinguish packets transmitted to/received from the tethered devices.

After receiving the tethered jitter information of the tethered device connected to the UE from the UE 301, the NG-RAN 302 may determine to accept and reject the PDU session establishment and modification request operation in consideration of a packet delay budget (PDB) within the service flow, based thereon.

In consideration of the PDB of the basic service and the actually measured network packet delay (AN PDB and core network (CN) PDB) based on a jitter range value considering packet loss of the service flow in addition to mean packet delay based on tethered jitter information, based on [Equation 1], the RAN 302 may reject the PDU session establishment and modification request when the corresponding value exceeds the PDB of the basic service flow.

Meanwhile, when the PDU session establishment and modification request operation is accepted, the NG-RAN 302 may configure the priority of packets for each service flow, based on a PDB value of the remaining service flow based on an AN PDB between the UE and the NG-RAN 302 and the mean packet delay value and the jitter range value within tethered jitter information, and perform packet scheduling, based thereon.

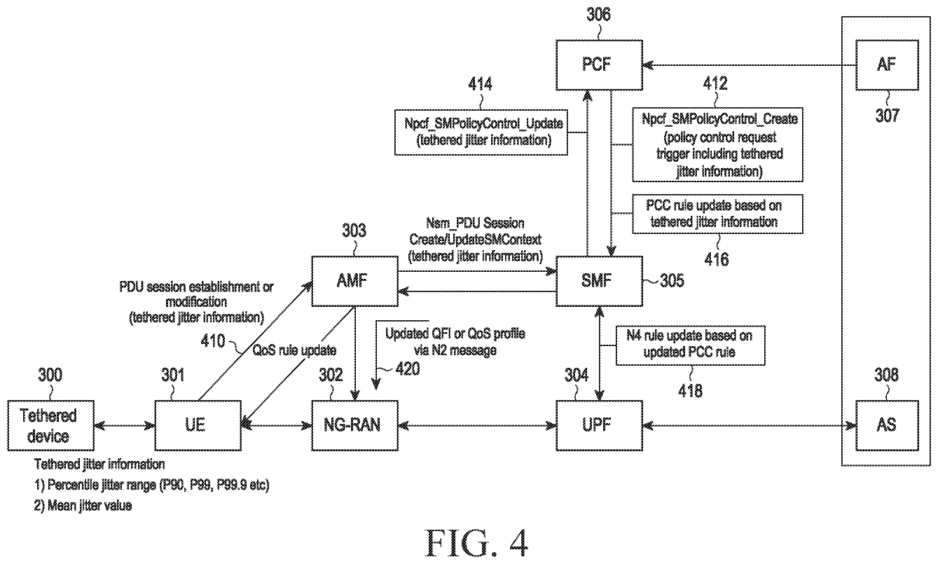

FIG. 4 is a diagram illustrating the operation in which the UE transfers the network transmission delay value including the tethered jitter information value of the tethered device connected to the UE to the network and a policy determination process indicating whether to update the service flow QoS, based on the corresponding information in the wireless communication system according to an embodiment of the disclosure.

Referring to FIG. 4, the wireless communication system may include at least one of the UE 301, the NG-RAN 302, the AMF 303, the UPF 304, the SMF 605, the PCF 306, the AF 307, or the application server (AS) 308.

The UE 301 may measure packet transmission delay information between the UE 301 and a tethered device connected to the UE 301, calculate the same, based on a statistical characteristic to generate tethered jitter information, and transfer the tethered jitter information to the SMF 305 in order to make a request for packet scheduling considering packet transmission of the corresponding tethered device.

The tethered jitter information may include at least one of a mean value of packet delay values of the tethered devices 300 connected to the UE 301 periodically measured during a predetermined time or a range value (P98, P99, P99.9, etc.) of a percentage-based delay change in which the corresponding packets are received.

Specifically, the range value of the percentage-based delay change in which the corresponding packets are received may indicate a rate at which packets transmitted from the tethered device 300 to the UE 301 are received based on packet loss of the corresponding service flow as shown in [Equation 1]. For example, when a value of the transmission delay change between the UE 301 and the tethered device 300 connected to the UE 301 is calculated as 99 percents (P99) based on a percentage-based jitter change value, the P99 may be a jitter range value of the statistical characteristic in which 99 percents of packets transmitted from the tethered device to the UE are successfully transmitted.

The UE 301 may transfer tethered jitter information considering the connection of the corresponding tethered device within a PDU session establishment or modification request message 410 to the SMF 305 through the AMF 303.

When the PCF 306 transfers a policy control request trigger related to tethered device jitter information to the SMF 305 through PDU session-related policy information after generating SM policy association (Npcf_SMPolicyControl_Create) in order to update policy information for a service considering the tethered device 300 during the PDU session establishment request process in operation 412, the SMF may transfer the corresponding information when receiving the tethered jitter information from the UE in operation 414.

The PCF 306 may determine whether to update the QoS of the current service, based on tethered device-related jitter information transferred from the UE 301. When a value considering the PDB of the QoS of the basic service flow and jitter information of an additional tethered device exceeds the allowable PDB, policy decision may be made to configure a new QoS. The PCF 306 may perform a procedure for applying the new QoS of the service flow considering the tethered device 300 by transferring the updated PCC rule information to the SMF in operation 416.

The SMF 305 may perform an N4 rule update process 418 to apply the new QoS rule to the UPF 304, based on the updated PCC rule received through the process 416. In addition, the SMF 305 may transfer QoS information of the updated service flow (at least one of updated QoS flow identifier (QFI), QoS profile, or QoS rule) to the UE 301 and the NG-RAN 302 in operation 420 so as to transmit the updated QoS information.

When the number of tethered devices connected to the UE 301 is plural, the SMF 305 may transfer QoS rule information including information (e.g. a DSCP value of the tethered device) for distinguishing each tethered device, information on the updated QoS flow associated with the tethered device, or the like to the UE 301 through the NG-RAN 302. The UE 301 receiving at least one piece of the information (e.g. the DSCP value of the tethered device) for distinguishing the tethered devices and the information on the updated QoS flow associated with the tethered devices through the QoS rule information may perform an operation for distinguishing packets transmitted to/received from the tethered devices. Through the processes, the service considering the tethered device 300 may be provided through the policy decision indicating whether to update the QoS of the service flow of the PCF 306, based on transmission jitter information of the tethered device connected to the UE.

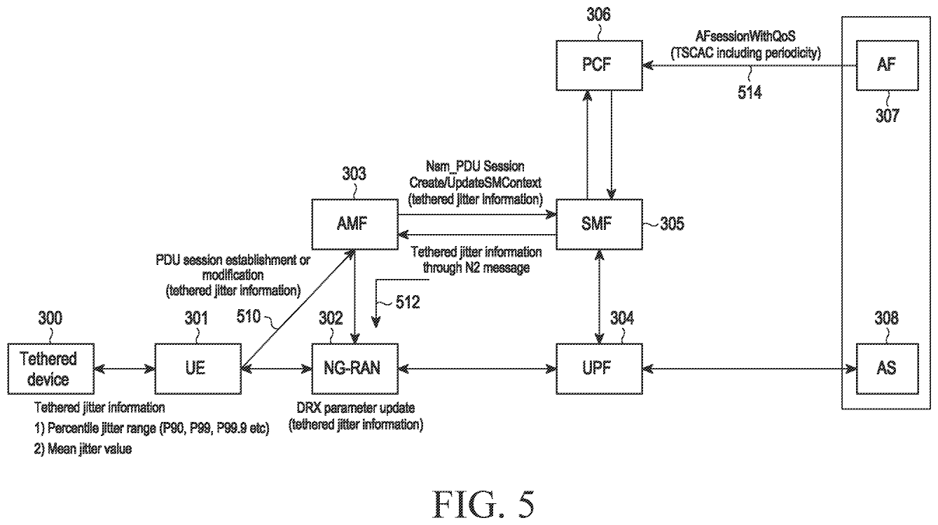

FIG. 5 is a diagram illustrating an operation in which a UE transfers a network transmission delay value including a tethered jitter information value of a tethered device connected to the UE to a network and a DRX parameter transmission process for a power-saving service, based on the corresponding information, in a wireless communication system according to an embodiment.

Referring to FIG. 5, the wireless communication system may include at least one of the UE 301, the NG-RAN 302, the AMF 303, the UPF 304, the SMF 305, the PCF 306, the AF 307, or the application server (AS) 308.

The UE 301 may measure packet transmission delay information between the UE and the tethered device 300 connected to the UE, calculate the same, based on a statistical characteristic to generate tethered jitter information, and transfer the tethered jitter information to the SMF 305 in order to make a request for packet scheduling considering packet transmission of the corresponding tethered device. According to a configuration of a network operator, the UE 301 may directly transfer the tethered jitter information to the SMF 305 through a NAS message or transfer the tethered jitter information to the SMF 305 through AF session-related QoS requirement information by using the AF 307. The tethered jitter information may include at least one of a mean value of packet delay values between the tethered device 300 connected to the UE 301 and the UE 301 periodically measured during a predetermined time or a range value (P98, P99, P99.9, etc.) of a percentage-based delay change in which the corresponding packets are received.

Specifically, the range value of the percentage-based delay change in which the corresponding packets are received may indicate a rate at which packets transmitted from the tethered device 300 to the UE 301 are received based on packet loss of the corresponding service flow as shown in [Equation 1]. For example, when a value of the transmission delay change between the UE 301 and the tethered device 300 connected to the UE 301 is calculated as 99 percents (P99) based on a percentage-based jitter change value, the P99 may be a jitter range value of the statistical characteristic in which 99 percents of packets transmitted from the tethered device 300 to the UE 301 are successfully transmitted.

The UE 301 may transfer tethered jitter information considering the connection of the corresponding tethered device within a PDU session establishment or modification request message 510 to the SMF 305 through the AMF 303.

The SMF 305 receiving the tethered jitter information from the UE 301 may include at least one piece of the corresponding tethered jitter information, direction information of the corresponding connection, and periodicity information of the packet transmitted to the tethered device received through the AF 307 in an N2 SM information message 512 including a time sensitive communication assistance information (TSCAI) container, a non-3GPP QoS assistance information container. tethered device assistance information container, or the like, and transmit the same to the NG-RAN 302 through the AMF 303.

The operation 512 in which the SMF 305 transfers the tethered jitter information considering the connection of the tethered device 300 connected to the UE 301 to the NG-RAN 302 may include an operation of determining a selectable jitter range considering packet loss information of the service flow or the like, based on percentage-based jitter change information received from the UE 301.

The UE 301 may use an XR service based on a normal environment that does not consider battery saving or a DRX parameter basically provided by a service operator through the RAN (for example, NG-RAN 302). According to user's selection, a UE battery state, or a currently serviced network state, the currently used XR service may not support a normal DRX function.

In the XR service based on a default DRX parameter provided by the service or network operator, the battery-saving service considering tethered jitter information (for example, DRX parameter update based on service characteristic (Contents type) or tethered device network condition (tethered jitter information etc.)) may be performed in consideration of the actual network environment of the tethered device connected to the UE.

The XR service may require large amounts of data to be processed, unlike the normal data-based service. In the case of video traffic, service traffic characteristics that require transmission of high-capacity data may appear in a predetermined pattern (e.g. a frame rate such as 90 fps or 120 fps). Further, in the case of video traffic, the size of data constituting the corresponding traffic may be different depending on content characteristics, and thus the size and number of packets constituting the corresponding traffic packets may be different.

Even in the service having the traffic characteristics indicating the predetermined pattern such as the video traffic, when the UE 301 transmits a packet received from the tethered device 300 connected to the UE 301, that is, in uplink packet transmission, a pattern of service traffic (periodicity or DRX cycle in DRX parameter) may vary depending on the network environment and/or service characteristics, and there is a need to update the service traffic pattern in consideration of the variation.

The AF 307 may determine to transfer battery (or power)-saving assistance information to the PCF 306 in order to provide the UE battery-saving service. The AF 307 may generate battery (power)-saving assistance information and transfer the same to the PCF 306 through a time sensitive communication assistance container (TSCAC) in operation 514.

The PCF 306 may perform an operation required for supporting battery saving of the corresponding service by receiving the battery-saving assistance information. The corresponding battery-saving assistance information may include at least one of information on whether battery saving is assisted (power-saving support indication), periodicity information of traffic currently serviced to the tethered device through a time sensitive communication assistance information (TSCAI) message, and determination information indicating whether to use tethered jitter information for battery saving when an uplink packet considering the tethered device is transmitted. The SMF receiving the TSCAC may generate the TSCAI, based on information within the TSCAC. The AF 307 may include at least one piece of periodicity information of traffic serviced to the tethered device and determination information indicating whether to use tethered jitter information for battery saving when the uplink packet considering the tethered device is transmitted in an AFsessionwithQoS message as separate information according to a configuration of the service operator without the use of a container such as the TSCAC and transfers the same to the PCF 306.

According to an embodiment, when there is no tethered jitter information-related requirement in the AFsessionwithQoS message including battery-saving service request information received from the AF 307 when the uplink packet considering a separate tethered device is transmitted, only the periodicity information of the packet serviced to the tethered device may be transferred to the NG-RAN 302 and thus a DRX cycle parameter update using only the periodicity information of the packet serviced to the tethered device may be performed.

According to an embodiment, when the tethered jitter information-related requirement (jitter range requirement) is included in the battery-saving assistance information when the uplink packet considering the tethered device is transmitted, the PCF 306 receiving the tethered jitter information-related requirement (jitter range requirement) from the AF 307 may know that the tethered jitter information is needed to consider the connection of the tethered device, and when the tethered jitter information is transferred to the SMF 305 through the UE 301 according to a policy of a network operator or the tethered jitter information is transferred to the SMF 305 through the AF 307, may transmit policy information to transfer the tethered jitter information to the NG-RAN 302.

When the battery-saving service considering the tethered jitter information is used, the PCF 306 may transfer at least one piece of periodicity information of the packet transferred to the corresponding tethered device (and received from the AF 307) and the tethered jitter information (received from the UE 301) to the NG-RAN 302 through the SMF 305 and perform the DRX parameter update by using the service periodicity information considering the basic jitter range based on the corresponding information. The UE 301 receiving the updated DRX parameter may provide the service based on the updated DRX parameter.

According to an embodiment, at least one of a periodicity and a service request indicator within the battery-saving service request message may be transmitted to the SMF 305 through the AF 307, or the UE 301 may transfer the battery-saving service request message including periodicity information of the packet in the service flow and the service request indicator within a PDU session establishment or modification request message to the SMF 305.

According to an embodiment, when the battery-saving service request message including the periodicity information of the packet in the service flow and the service request indicator are included in the PDU session establishment or modification request message transmitted from the UE 301, the SMF 305 may make a request for a policy information update request or policy information to the PCF 306 and determine whether to perform the corresponding service, based on the request information on the relevant battery-saving service from the UE 301.

The NG-RAN 302 receiving the tethered jitter information and the battery-saving service request message including the periodicity information of the packet in the service flow and the service request indicator from the UE 301 may determine the DRX parameter update, based on the corresponding information. When the corresponding DRX parameter update is determined, the NG-RAN 302 may transfer the same to the UE 301 through an RRC connection reconfiguration message and perform an operation of updating DRX parameters for the battery-saving service operation of the corresponding XR service.

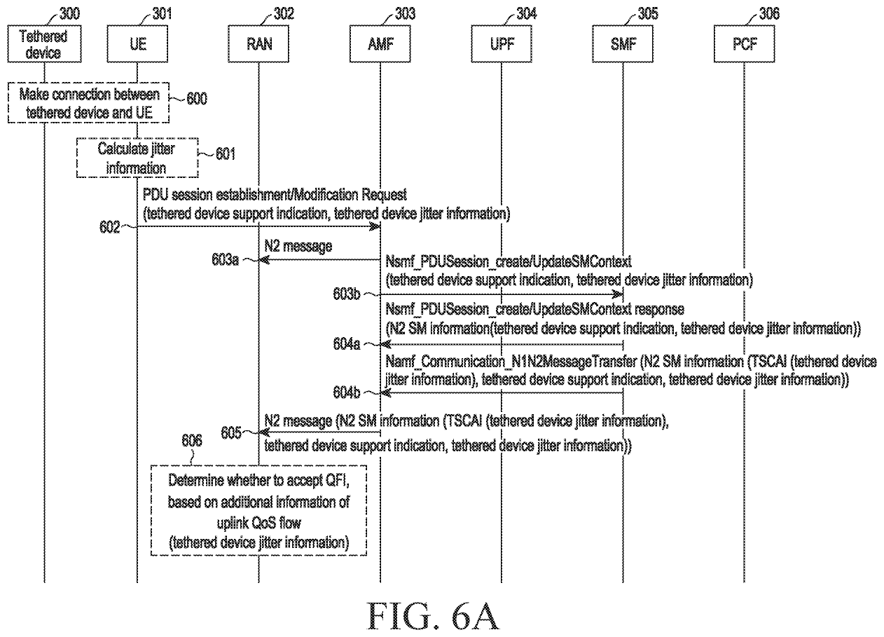

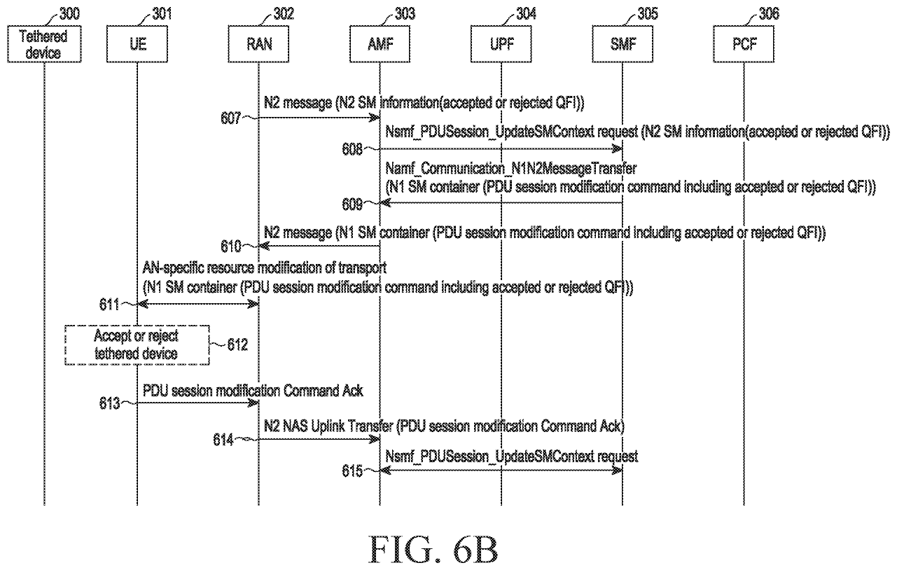

FIG. 6 is a flowchart illustrating an operation in which the UE transfers packet transmission delay values of a tethered device connected to the UE to the network and then the network accepts or rejects a PDU session modification request of the corresponding service flow in the wireless communication system according to an embodiment of the disclosure.

In operation 600, the user may select to use the service through the tethered device 300 during the use of the service or when the service is connected. For example, while the user uses an XR service constituted by the video and audio service flow through the UE 301, the user may determine to separately make a connection to wireless earphones in the case of the audio service flow or may select to use the service using the tethered device 300 through a separately connected headset in the case of the video service flow, In operation 601, the UE 301 may transfer at least one piece of tethered device network delay information including tethered device jitter information of the tethered device 300 connected to the UE 301 and tethered device support indication information to the network and make a request for providing the service considering the corresponding tethered device 300. The UE 301 may periodically or aperiodically make an actual measurement for packet data between the actual tethered device 300 and the UE 301, transmit network delay information including tethered device jitter information, based on the corresponding actually measured information or transmit information such as the tethered device network type or the codec (codec type, etc.) according a policy of a service operator or a network operator, and the tethered device network delay information may be used after being switched to predetermined network delay information, based on the information, according to a service level agreement (SLA). The UE 301 may transfer at least one piece of tethered device-related information among tethered device connection information such as network delay information including tethered device jitter information based on the actually measured information, the type of the network of the tethered device, or codec (tethered device network type, codec type, etc.) to the network (for example, the SMF 305) or transfer the same to the SMF 305 through the AF 307. For example, if the user uses a Bluetooth connection and aptX-LL codec after determining an additional tethered device connection for an audio service through wireless earphones when the UE 301 transmits tethered device-related information based on tethered device connection information, based on the assumption of the (ideal) transmission delay time of 34 ms, the UE may transmit tethered device-related connection information including at least one of tethered device network type information including the Bluetooth connection information and service packet information transmitted to the tethered device including aptX-LL codec type information or the like through a service flow establishment or modification request (PDU session establishment or modification request) message considering the corresponding wireless tethered device connection, and the network (for example, SMF 305) may receive the tethered device connection information and then map the tethered device connection information to the (ideal) transmission delay time of 34 ms and use the same.

In the disclosure, after the connection or modification of the service using the tethered device 300 is determined in operation 600, the UE 301 may perform a process of monitoring packets from the tethered device 300 for a predetermined period and then calculating network delay information having a statistical characteristic, based on the corresponding value, and transfer the corresponding information to the network. The network delay information having the statistical characteristic may include a mean packet delay value, a percentage-based jitter range value (percentiles value of jitter range), or the like. The percentage-based jitter range value is information (value) that expresses packets arriving within a predetermined jitter range of packets arriving from the tethered device 300 to the UE 301 in the percentile form and may be expressed as a jitter range (P98) in which packets of 98% successfully arrive or a jitter range (P99) in which packets of 99% successfully arrive. The UE 301 may transfer one or more percentage-based jitter ranges to the network through tethered device jitter information. For example, the NG-RAN 302 receiving various percentage-based jitter ranges within the tethered device jitter information for packet scheduling may select an appropriate jitter range from among the percentage-based jitter ranges in consideration of packet loss of the service flow or the like.

In operation 602, the UE 301 may transfer a PDU session establishment or modification request message including at least one of the statistical tethered device jitter information and the tethered device support indication information measured in operation 601 to the AMF 303.

In operation 603a, when a make a request for updating the corresponding tethered device jitter information is made periodically or when an event occurs in the UE after a service connection request for supporting the tethered device has been already completed according to a policy of the network operator, the AMF 303 may directly transfer the same to the NG-RAN 302 without passing through the SMF 305. Like in operation 603a, the process of operations 603b to 615 may be omitted when a PDU session modification request for updating the tethered device jitter information is made.

When there is no separate operator policy, the AMF 303 may transfer at least one of the tethered device support indication and the tethered device jitter information received from the UE in operation 602 to the SMF 305 through a PDU session-related session management context generation or PDU session-related session management context update (Nsmf_PDUSession_CreateSMContext or Nsmf_PDUSession_UpdateSMContext) service operation in operation 603b.

In operation 604a or operation 604b, the SMF 305 may transfer at least one of the tethered device support indication and the tethered device jitter information received from the UE in operation 603b to the AMF 303 through N2 session management (SM) information. When the UE 301 uses the XR service and supports a power-saving mode in the corresponding XR service, the SMF 305 may transmit the tethered device jitter information to the AMF 303 by using an N2 SM information message 604b including a TSCAI container, a non-3GP QoS assistance information container, a tethered device assistance information container, or the like in operation 604b. However, when the UE does not use the XR service or uses a separate XR service that does not support the power-saving mode, N2 session management information including at least one of the tethered device jitter information and the tethered device support indication information may be transferred to the AMF 303 in order to support the service using the tethered device within a PDU session-related session management context generation or update response message in operation 604a. In addition, when the number of tethered devices connected to the UE 301 is one or more, the SMF 305 may transfer an N1 SM container including QoS rule information including separation information for mapping packets transmitted from the UE to the tethered device 300 or transmitted from the tethered device 300 to the UE 301 to the appropriate QoS flow to the AMF 303.

In operation 605, the AMF 303 receiving the information for supporting the tethered device in operation 604 may transfer the information to the NG-RAN 302 through the N2 message. When the AMF 303 receives the tethered device jitter information in operation 604b, the tethered device jitter information may be transmitted through the N2 SM information message including the TSCAI container, and when the TSCAI container is not supported, information for supporting the tethered device such as the tethered device jitter information and the tethered device support indication may be transferred to the NG-RAN 302 through the N2 SM information message including the non-3GPP QoS assistance information container or the tethered device assistance information container. In addition, when the number of tethered devices connected to the UE 301 is one or more, the SMF 305 may transfer QoS rule information including separation information for mapping packets transmitted from the UE 301 to the tethered device 300 or transmitted from the tethered device 300 to the UE 301 to the appropriate QoS flow to the NG-RAN 302 through the N2 message included in the NI SM container. The NG-RAN 302 receiving the tethered device jitter information and the tethered device support indication information for supporting the tethered device service in operation 605 may determine whether to accept or reject the corresponding request (accepted or rejected QFI), based on the tethered device information within the corresponding PDU session establishment or modification request message in operation 606.

For example, the NG-RAN 302 may determine whether to support the service flow due to the XR service connection of the UE or the additional tethered device connection during the XR service, and when the QoS of the basic XR service flow is not satisfied based on additional tethered device assistance information of the corresponding XR service flow, may reject the corresponding request and inform the UE 301 of the rejection, and the UE 301 may perform again operations 601 to 606 after determining a change in the type of the network connected to the tethered device, based on the corresponding rejection information, or a change in the network, based on the signal strength.

When the corresponding PDU session establishment or modification request information including the tethered device information can be accepted based on the service flow QoS, the NG-RAN 302 may perform packet scheduling, based on the corresponding tethered device jitter information. Further, when the tethered device jitter range information measured by the UE 301 in operation 601 has one or more percentile-based jitter ranges, the NG-RAN 302 may select an appropriate jitter range value in consideration of policy information such as packet loss.

Through the process from operation 607 to operation 608, the RAN 302 may transfer the result value of the PDU session establishment or modification request (operation 602) considering the tethered device requested by the corresponding UE 301 to the SMF 305 through the AMF 303.

Through the process from operation 609 to operation 611, the SMF 305 may transfer the result value of the PDU session establishment or modification request 302 considering the tethered device requested by the UE 301, based on the information received from the NG-RAN 302, to the UE 301 by using PDU session modification command information. In addition, when the number of tethered devices connected to the UE 301 is one or more, the SMF 305 may transfer QoS rule information including separation information for mapping packets transmitted from the UE 301 to the tethered device 300 or transmitted from the tethered device 300 to the UE 301 to the appropriate QoS flow to the UE 301.

The UE 301 receiving the PDU session modification command information 611 may identify whether the PDU session establishment or modification request considering the tethered device is accepted or rejected in operation 612. Further, when the UE 301 is connected to one or more tethered devices, the UE 301 may update packet filter information of the UE 301, based on QoS rule information including separation information for mapping packets transmitted between the tethered device 300 and the UE 301 to the appropriate QoS flow.

When the PDU session establishment or modification request considering the tethered device within the PDU session modification command information is accepted, the UE 301 may transfer a response message of the corresponding PDU session modification command information to the SMF 305 in operation 613 to operation 615.

When the PDU session establishment or modification request considering the tethered device within the PDU session modification command information is rejected, the UE 301 may perform operations 601 to 606 again after determining the change in the type of the network connected to the tethered device, based on the corresponding rejection information, or the change in the network, based on the signal strength.

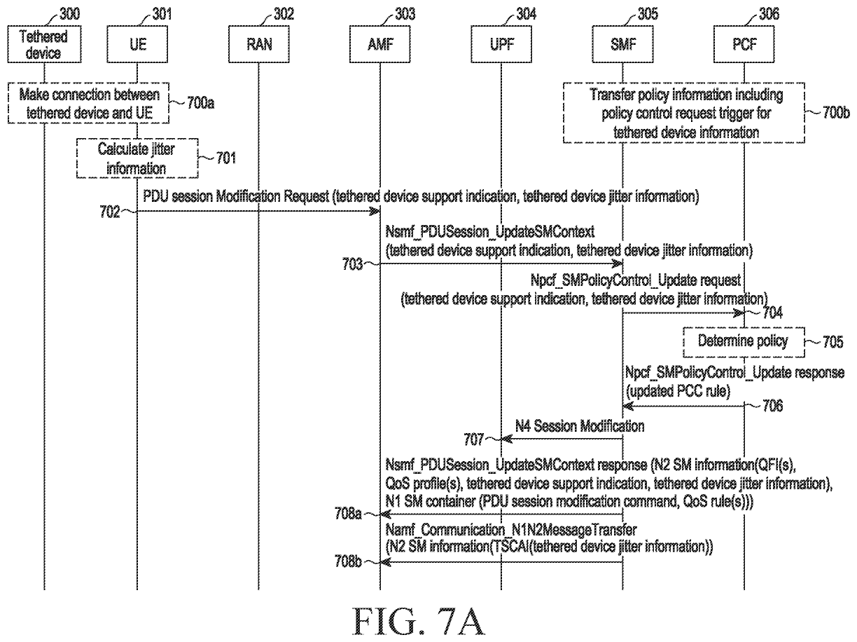

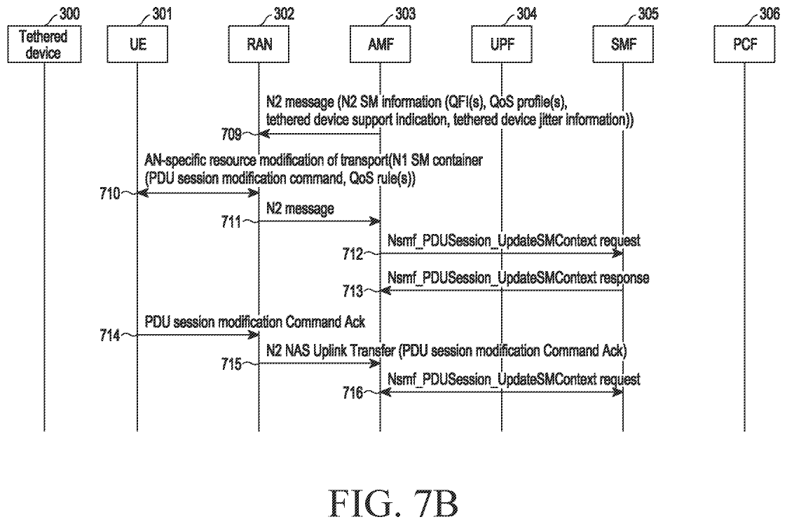

FIG. 7 is a flowchart illustrating an operation in which a UE transfers a network transmission delay value including a tethered jitter information value of a connected tethered device and a process of determining a policy indicating whether to update the service flow QOS, based on the corresponding information, in a wireless communication system according to an embodiment of the disclosure.

In operation 700a, a user may select to use a service through the tethered device 300 during the use of the service or when making a connection to the service. For example, while the user uses an XR service constituted by the video and audio service flow through the UE, the user may determine to separately make a connection to wireless earphones in the case of the audio service flow or may select to use the service using the tethered device 300 through a separately connected headset in the case of the video service flow.

When tethered device-related information or tethered device jitter information is transferred from the UE 301 to the SMF 305, the PCF 306 may transfer policy information including a policy control request trigger through the SMF 305 informs the PCF 306 of the information to the SMF 305 in operation 700b.

In operation 701, the UE 301 may transfer tethered device network delay information of the tethered device 300 connected to the UE 301 to the network and make a request for providing the service considering the corresponding tethered device. The UE 301 may periodically or aperiodically make an actual measurement for packet data between the actual tethered device 300 and the UE 301, transmit network delay information including tethered device jitter information, based on the corresponding actually measured information or transmit information such as the tethered device network type or the codec (codec type, etc.) according a policy of a service operator or a network operator, and the tethered device network delay information may be used after being switched to predetermined network delay information, based on the information, according to a service level agreement (SLA).

In the disclosure, after the connection or modification of the service using the tethered device 300 is determined in operation 700a, the UE 301 may perform a process of monitoring packets from the tethered device 300 for a predetermined period and then calculating network delay information having a statistical characteristic, based on the corresponding value, and transfer the corresponding information to the network. The network delay information having the statistical characteristic may include a mean packet delay value, a percentage-based jitter range value (percentiles value of jitter range), or the like. The percentage-based jitter range value is information (value) that expresses packets arriving within a predetermined jitter range of packets arriving from the tethered device 300 to the UE 301 in the percentile form and may be expressed as a jitter range (P98) in which packets of 98% successfully arrive or a jitter range (P99) in which packets of 99% successfully arrive. The UE 301 may transfer one or more percentage-based jitter ranges to the network through tethered device jitter information. For example, the NG-RAN 302 receiving various percentage-based jitter ranges within the tethered device jitter information for packet scheduling may select an appropriate jitter range from among the percentage-based jitter ranges in consideration of packet loss of the service flow or the like.

In operation 702, the UE 301 may transfer a PDU session modification request message including at least one of the statistical tethered device jitter information measured in operation 701, the tethered device network type, the codec (codec type, etc.), teethed device-related connection information, and tethered device support indication information to the AMF 303.

In operation 703, the AMF 303 may transfer at least one of the tethered device support indication, the tethered device network type, the codec (codec type, etc.), the tethered device-related connection information, and the tethered device jitter information received from the UE through operation 702 to the SMF 305 through a PDU session-related session management context update (Nsmf_PDUSession_UpdateSMContext) service.

In operation 704, when the SMF 305 has tethered device-related policy information through operation 700b, if tethered device-related information including the corresponding tethered device jitter information or tethered device support indication information is received, the SMF may determine that a policy control request trigger condition is satisfied and transfer tethered device-related information including at least one of the corresponding tethered device jitter information, the tethered device network type, the codec (codec type, etc.), the tethered device-related connection information, and the tethered device support indication to the PCF 306 through a session management policy control update request message (Npcf_SMPolicyControl_Update request).

In operation 705, the PCF 306 may determine whether the QoS of the current service flow supports an additional tethered device connection, based on the tethered device jitter information and, when the service flow considering additional tethered device jitter information does not satisfy the QoS of the existing service flow, perform policy decision of determining to update the QoS of the service flow connected to the corresponding tethered device.

In operation 706, the PCF 306 may transfer an updated PCC rule based on new QoS considering the tethered device connection to the SMF 305. When the PCF 306 does not determine the update to the new QoS in operation 705, the updated PCC rule information may not be included in the message transferred to the SMF 305 in operation 706.

When the SMF 305 receives the updated PCC rule in operation 706, the SMF 305 may transfer relevant QoS update information (updated QFI, etc.) to the UPF 304 through an N4 rule update process in operation 707. When the SMF 305 does not receive the updated PCC rule in operation 706, operation 707 may be omitted.

In operation 708a or operation 708b, the SMF 305 may transfer the tethered device support indication and the tethered device jitter information received from the UE 301 in operation 703 to the AMF 303 through N2 session management (SM) information. When the UE 301 uses the XR service and supports a power-saving mode in the corresponding XR service, the SMF 305 may transmit the tethered device jitter information to the AMF 303 by using N2 SM information including a TSCAI container, a non-3GP QoS assistance information container, or a tethered device assistance information container in operation 708b. However, when the UE does not use the XR service or uses a separate XR service that does not support the power-saving mode, N2 session management information including the tethered device jitter information and the tethered device support indication information may be transferred to the AMF 303 in order to support the service using the tethered device within a PDU session-related session management context generation or update response message in operation 708a. When the SMF 305 receives the updated PCC rule in operation 706, the SMF 305 may also transmit updated QoS information related to the service flow including an updated QoS profile or the like in operation 708a.

The AMF 303 receiving information for supporting the tethered device including the tethered device support indication and the tethered device jitter information in operation 708 may transfer the same to the NG-RAN 302 through the N2 message in operation 709. When the AMF 303 receives the tethered device jitter information through N2 SM information including the TSCAI container, the non-3GPP QoS assistance information container, or the tethered device assistance information container in operation 708b, the N2 message including the TSCAI container, the non-3GPP QoS assistance information container, or the tethered device assistance information container may be transmitted, and when the TSCAI container, the non-3GPP QoS assistance information container, or the tethered device assistance information container is not supported, the N2 message separately including information for supporting the tethered device such as the tethered device jitter information and the tethered device support indication may be transferred to the NG-RAN 302.

In operation 709, the NG-RAN 302 receiving the tethered device jitter information and the tethered device support indication information for supporting the tethered device service may perform packet scheduling, based on the corresponding tethered device jitter information. Further, when the tethered device jitter range information measured by the UE in operation 701 has one or more percentile-based jitter ranges, the NG-RAN 302 may select an appropriate jitter range value in consideration of policy information such as packet loss.

The NG-RAN 302 may transfer result and response messages for the PDU session modification request considering the tethered device requested by the corresponding UE through the processes (operations 702 to 709) to the UE 301 in the process of operations 710 to 716, receive response information from the UE 301, and transfer the response information to the SMF 305 through the AMF 303. Further, when the NG-RAN 302 receives the service flow QoS update and the updated PCC rule, based on the tethered device-related information in operations 705 and 706, the NG-RAN 302 may transfer an N1 SM container including QoS information including the updated QFI information (updated QoS rule, etc.) to the UE 301. In addition, when the number of tethered devices connected to the UE 301 is one or more, the SMF 305 may transfer QoS rule information including separation information for mapping packets transmitted from the UE 301 to the tethered device 300 or transmitted from the tethered device 300 to the UE 301 to the appropriate QoS flow to the UE 301. When the UE 301 is connected to one or more tethered devices, the UE 301 may update packet filter information of the UE 301, based on the QoS rule information including the separation information for mapping packets transmitted between the tethered device 300 and the UE 301 to the appropriate QoS flow.

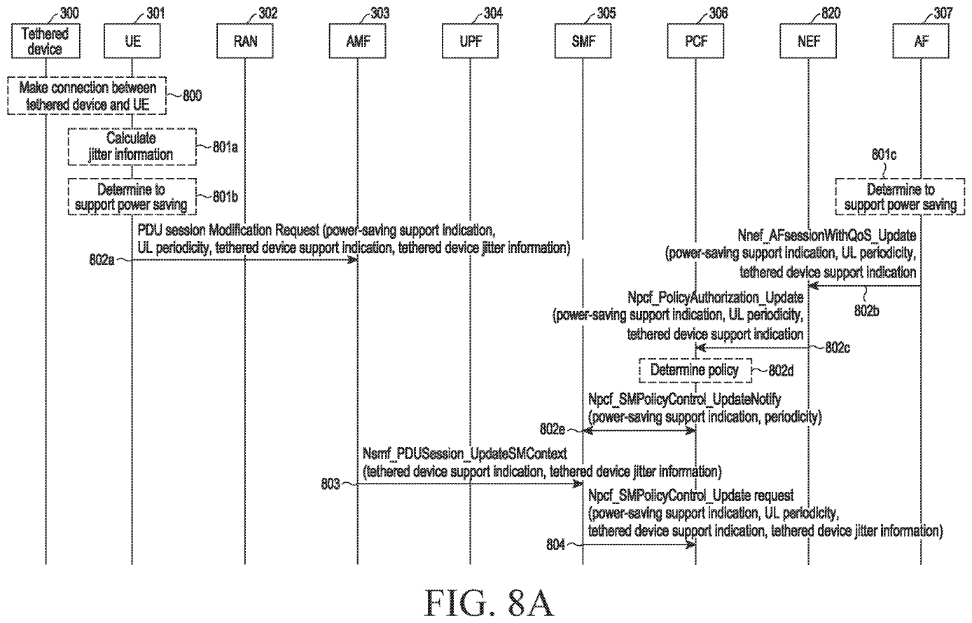

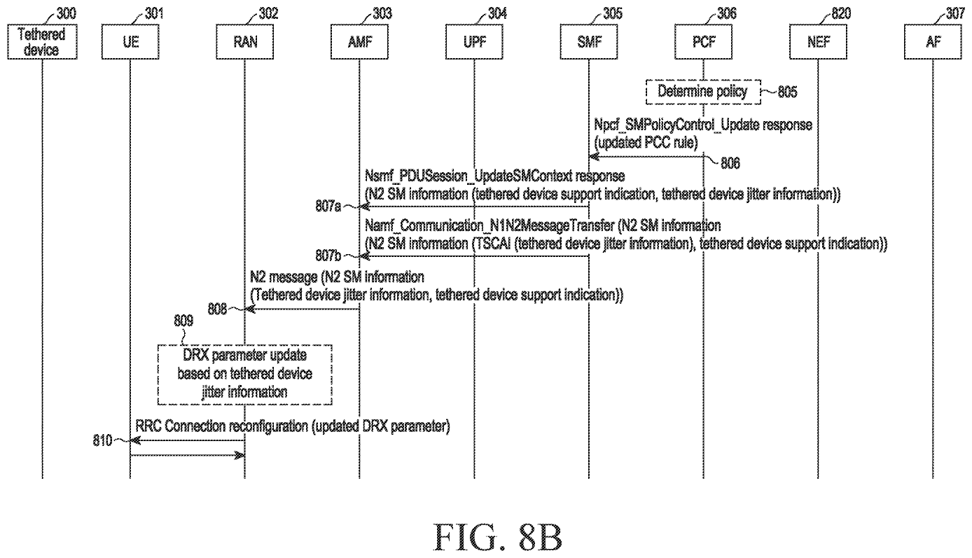

FIG. 8 is a flowchart illustrating a process in which the UE transfers packet transmission delay values of tethered devices connected to the UE to the network and then updates a DRX parameter, based on the same, in the wireless communication system according to another embodiment of the disclosure.

In operation 800, the user may select to use the service through the tethered device during the use of the service or when the service is connected. For example, while the user uses an XR service constituted by the video and audio service flow through the UE, the user may determine to separately make a connection to wireless earphones in the case of the audio service flow or may select to use the service using the tethered device 300 through a separately connected headset in the case of the video service flow.

In operation 801a, the UE 301 may transfer tethered device network delay information of the tethered device 300 connected to the UE 301 to the network and make a request for providing the service considering the corresponding tethered device. The UE 301 may periodically or aperiodically make an actual measurement for packet data between the actual tethered device 300 and the UE 301, transmit network delay information including tethered device jitter information, based on the corresponding actually measured information or transmit information such as the tethered device network type or the codec (codec type, etc.) according a policy of a service operator or a network operator, and the tethered device network delay information may be used after being switched to predetermined network delay information, based on the information, according to a service level agreement (SLA), In the disclosure, after the connection or modification of the service using the tethered device is determined in operation 800, the UE 301 may perform a process of monitoring packets from the tethered device 300 for a predetermined period and then calculating network delay information having a statistical characteristic, based on the corresponding value, and transfer the corresponding information to the network. The network delay information having the statistical characteristic may include a mean packet delay value, a percentage-based jitter range value (percentiles value of jitter range), or the like. The percentage-based jitter range value is information (value) that expresses packets arriving within a predetermined jitter range of packets arriving from the tethered device to the UE in the percentile form and may be expressed as a jitter range (P98) in which packets of 98% successfully arrive or a jitter range (P99) in which packets of 99% successfully arrive. The UE 301 may transfer one or more percentage-based jitter ranges to the network through tethered device jitter information. For example, the NG-RAN 302 receiving various percentage-based jitter ranges within the tethered device jitter information for packet scheduling may select an appropriate jitter range from among the percentage-based jitter ranges in consideration of packet loss of the service flow or the like.

In operation 801b, the UE 301 may determine whether to make a request for supporting power saving, based on UE battery state information or the like when the XR service is used.

In operation 801c, the UE 301 may transfer the battery saving request information to the network through the AF when the XR service is used. In the case of power saving considering a downlink packet during the XR service through the connection of the tethered device, the AF 307 may receive periodicity information of the packet transmitted through the downlink in operation 801c. In order to use the power-saving service considering the uplink packet during the XR service through the connection of the tethered device, DL/UL periodicity information may be needed. The UE may transfer the corresponding UL periodicity information to the separate AF 307, or when the AF 307 already knew the periodicity information of the packet transmitted through the uplink, the AF may transfer DL/UL periodicity information to the network. However, when the UE 301 cannot transfer periodicity information of the uplink packet transmitted by the corresponding tethered device through a separate channel to the AF 307 through a separate channel or the like, the UE 301 may transmit at least one piece of uplink packet periodicity information and power-saving support indication information within a PDU session establishment or modification request message in operation 802a together with tethered device-related information including tethered device jitter information or the like.

In operation 802a, when transmitting uplink data generated or occurring in the connected tethered device 300 to the network, the UE 301 may transfer a PDU session establishment or modification request message including at least one of a power-saving support indication for using the power-saving service, uplink periodicity (uplink packet periodicity (UL periodicity)) information, a tethered device support indication informing the network of the use of the service through the connection of the tethered device, or tethered device jitter information according to the connection of the corresponding tethered device to the AMF 303.

When the UE 301 cannot transmit uplink data transmission information through a separate connection with the AF 307, the power-saving support indication or the uplink periodicity (uplink packet periodicity or UL periodicity) information may be included in the PDU session establishment or modification request message and then transmitted in operation 802a.

When the UE 301 and the AF 307 are able to exchange power saving-related information through a separate channel, the AF 307 may transfer the power saving-related information including uplink periodicity information to the PCF 306 of the network through the NEF 820 by using an operation for supporting the power-saving service of the existing XR service in operation 802b and operation 802c. Based on whether the corresponding uplink periodicity information is received (through operation 801c), the AF 307 may determine a policy indicating whether to include the uplink periodicity information when the XR service power-saving operation is performed, and when the AF 307 has the uplink periodicity, information for uplink power saving may be transferred to the PCF 306 of the network through operation 802b and operation 802c.

Based on power-saving service requirements transmitted from the AF 307, the PCF 306 may perform a PCC rule update in operation 802d. The PCF 306 may perform the PCC rule update for providing the power-saving service of the uplink packet, based on at least one of information indicating whether the tethered device is connected (tethered device support indication) and uplink periodicity information when the power-saving service of the uplink packet of the corresponding service flow is provided or jitter-related requirement information indicating that the corresponding tethered device jitter information is transferred from the UE to the SMF (when the corresponding uplink packet is connected to the tethered device). In addition, like in operation 700b of FIG. 7, when the tethered device jitter information arrives within a policy control request trigger in policy information, the PCF 306 may make a request for transferring the same to the PCF 306 to the SMF 305. Further, the PCF 306 may include SMF 305 operation-related information in the policy rule (PCC rule) and transfer the same to the SMF 305 in order to update information within the TSCAL based on the tethered device jitter information transmitted from the UE 301 and transfer the corresponding TSCAI information to the NG-RAN 302.

In operation 802e, through the process 802d, the PCF 306 may transfer the updated PCC rule to the SMF 305 and make a request for the operation for power saving of the UE that transmits the uplink packet.

In operation 803, the AMF 303 may transfer the tethered device support indication and the tethered device jitter information received from the UE 301 in operation 802a and information related to the power-saving service including the power-saving support indication and the uplink periodicity information according to a configuration of the policy by the service operator to the SMF 305 through a PDU session-related session management context update (Nsmf_PDUSession_UpdateSMContext) message.

When the PCF 306 has not received separate information related to power saving from the AF 307 and thus operation 802b to operation 802e are omitted, that is, when the SMF 305 has not received the PCC rule including information related to the power-saving service from the PCF 306, the SMF 305 may perform an operation of transferring tethered device-related information including at least one of the information related to power saving including the power-saving support indication or the uplink periodicity information separately received from the UE 301, the tethered device support indication, or the tethered device jitter information to the PCF 306 in operation 804. Further, when there is a separate request for transferring tethered device jitter information to the PCF 306 in the policy information including a policy control request trigger, the SMF 305 may transfer tethered device-related information including at least one of the tethered device support indication or the tethered device jitter information to the PCF 306.

When there is no policy rule for a separate power-saving service received from the AF 307, the PCF 306 may determine a policy rule (PCC rule) update for supporting the power-saving service considering the tethered device in operation 805, based on at least one piece of the tethered device-related information and the information related to power saving received in operation 804. For example, as described in the disclosure, when the UE 301 receives uplink periodicity information, tethered device jitter information, or the like, the PCF 306 may know that the UE 301 is connected to the tethered device through the tethered device support indication, in which case the PCF 306 may determine a policy for updating TSCAI information transferred to the NG-RAN 302 to support uplink information power saving, based on at least one of the uplink packet periodicity information (UL periodicity) and the uplink power-saving support indication to support power saving of the uplink packet.

In operation 806, the PCF 306 may transfer the updated PCC rule to the SMF 305 and update the policy for performing the SMF operation to support the power-saving service of the UE 301 that transmits the uplink packet consideration of the tethered device.

The SMF 305 receiving the updated policy including the information related to power saving from the PCF 306 through operation 802e or operation 806 may transfer the same to the AMF 303 in operations 807a and 807b. When the PCF 306 determines to use the power-saving service based on the XR service through the PCC rule, the SMF 305 may transfer tethered device-related information to the NG-RAN 302 through the TSCAI via the AMF 303 in operation 807b. When the PCF 306 determines not to use the power-saving service based on the XR service, the SMF 305 may transfer N2 SM information including tethered device-related information to the AMF 303 in operation 807a. In addition, when the number of tethered devices connected to the UE 301 is one or more, the SMF 305 may transfer an NI SM container including QoS rule information including separation information for mapping packets transmitted from the UE 301 to the tethered device 300 or transmitted from the tethered device 300 to the UE 301 to the appropriate QoS flow to the AMF 303. In operations 807a and 807b, the AMF 303 receiving the tethered device-related information from the SMF 305 may transfer the same to the NG-RAN 302 through an N2 message in operation 808.

The NG-RAN 302 may determine a DRX cycle parameter update in operation 809, based on the tethered device jitter information received through operation 808.

In operation 810, the NG-RAN 302 may transfer updated DRX parameters to the UE 301 through an RRC connection reconfiguration process. When the UE 301 is connected to one or more tethered devices, the NG-RAN 302 may transfer QoS rule information including separation information for mapping packets transmitted between the tethered device 300 and the UE 301 to the appropriate QoS flow to the UE 301. The UE 301 may update uplink packet filter information of the UE 301, based on separation information of packets transmitted from the tethered device and mapping information for mapping packets transmitted from the tethered device to the appropriate QoS flow.

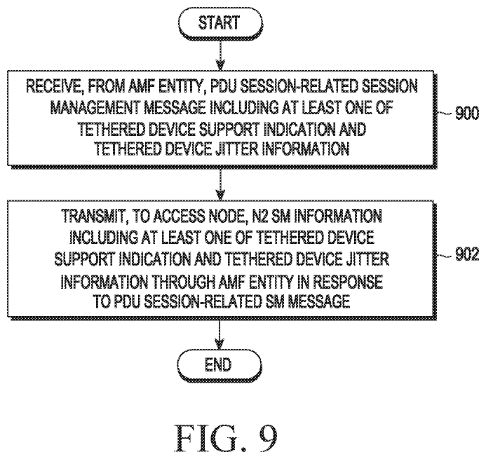

FIG. 9 is a diagram illustrating a method of an SMF entity supporting uplink scheduling of the UE using a tethered device according the disclosure.

The SMF entity may receive a protocol data unit (PDU) session-related session management (SM) message including at least one of a tethered device support indication and tethered device jitter information from the AMF entity in operation 900, 603b, 703, or 803. The PDU session-related SM message may be a PDUSession CreateSMContext message or a PDUSession_UpdateSMContext message.

The SMF entity may transmit N2 SM information including at least one of the tethered device support indication and the tethered device jitter information to the access node (AN) through the AMF entity in response to the PDU session-related SM message in operation 902, 604a, 604b, 605, 708a, 708b, 709, 807a, 807b, or 808. The access node may be the RAN 102 or the NG-RAN 302 described in the specification, for example, a base station, an eNB, a gNB, or the like. The N2 SM information message may include a time sensitive communication assistance information (TSCAI) container, a non-3GPP QoS assistance information container, or a tethered device assistance information container based on the tethered device jitter information (for example, when the updated PCC rule supports power saving). The N2 SM information may further include an updated QoS profile.

The SMF entity may transmit an SM policy control update request message including at least one of the tethered device support indication and the tethered device jitter information to the PCF entity in operation 704 or 804. The SM policy control update request message may include power-saving assistance-related information related to the uplink periodicity information.

The SMF entity may receive a response message including the updated PCC rule in response to the SM policy control update request message in operation 706 or 806. The updated PCC rule may include information related to power saving.

The SMF entity may receive a message including result value for a PDU session establishment or modification request from the AMF entity. The result value may be determined based on the N2 SM information.

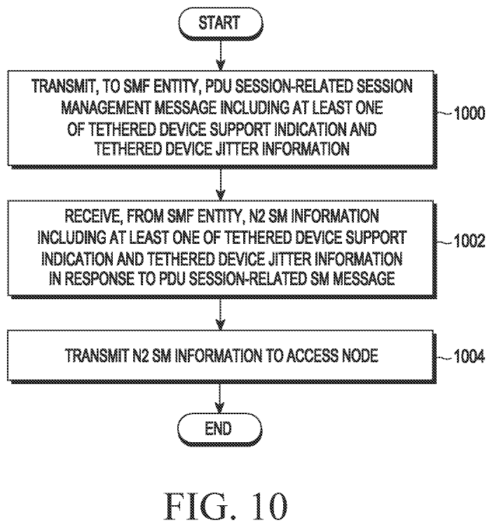

FIG. 10 is a diagram illustrating a method of an AMF entity supporting uplink scheduling of the UE using a tethered device according the disclosure.

The AMF entity may transmit a PDU session-related session management message including at least one of a tethered device support indication and tethered device jitter information to the SMF entity in operations 1000, 603b, 703, or 803. The PDU session-related SM message may be a PDUSession CreateSMContext message or a PDUSession_UpdateSMContext message.

The AMF entity may receive N2 SM information including at least one of the tethered device support indication and the tethered device jitter information from the SMF entity in response to the PDU session-related SM message in operation 1002, 604a, 604b, 708a, 708b, 807a, or 807b. The access node may be the RAN 102 or the NG-RAN 302 described in the specification, for example, a base station, an eNB, a gNB, or the like. The N2 SM information message may include a time sensitive communication assistance information (TSCAI) container, a non-3GPP QoS assistance information container, or a tethered device assistance information container based on the tethered device jitter information (for example, when the updated PCC rule supports power saving). The N2 SM information may further include an updated QoS profile.

The AMF entity may transmit the N2 SM information to the access node (AN) in operation 1004, 605, 709, or 808.

The AMF entity may transmit a message including a result value for a PDU session establishment or modification request to the SMF entity in operation 608. The result value may be determined based on the N2 SM information.

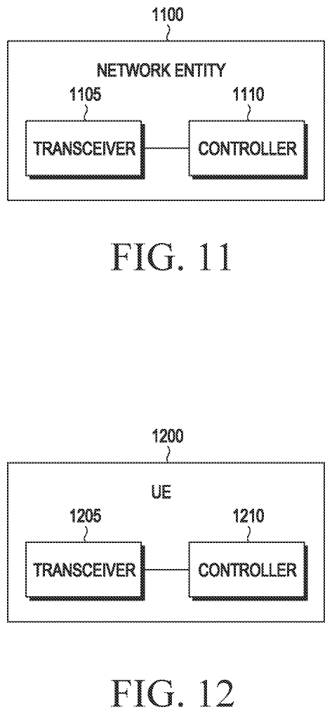

FIG. 11 illustrates a device structure of a network entity according to the disclosure.

The network entity device illustrated in FIG. 11 may be an entity (SMF, PCF, AMF, AF, NEF, UPF, RAN, or the like) device in the core network, illustratively described in the disclosure.

The network entity 1100 may include a transceiver 1105 which performs signal transmission and reception with other network entities or UEs, and a controller 1110 which controls the overall operation of the network entity 1100. It may be appreciated that all the methods performed by entities, such as an SMF, a PCF, an AMF, an AF, an NEF, a UPF, and an RAN, in the disclosure are performed under the control of the controller 1110.

Of course, the controller 1110 and the transceiver 1105 are not necessarily implemented as separate devices, but may be implemented as a single component unit such as a single chip. The controller 1110 may be implemented as one processor in the network entity 1100.

FIG. 12 illustrates a device structure of a UE according to the disclosure.

The UE 1200 illustrated in FIG. 12 may be a UE device illustratively described in the disclosure.

The UE 1200 may include a transceiver 1205 which performs signal transmission and reception with other UEs or network entities, and a controller 1210 which controls the overall operation of the UE 1200. It will be appreciated that all the operations or methods in the UE as described above in the disclosure are performed under the control of the controller 1210.

Of course, the controller 1210 and the transceiver 1205 are not necessarily implemented as separate devices, but may be implemented as a single component unit such as a single chip. The controller 1210 may be implemented as one processor in the UE 1200.

It should be noted that system configuration diagrams, method illustrations, and signal flowcharts illustrated in FIGS. 1 to 12 are not intended to limit the scope of protection of the disclosure. That is, all the constituent units or operation steps shown in FIGS. 1 to 12 should not be construed as essential elements for implementing the disclosure, and even when including only some of the elements, the disclosure may be implemented without impairing the true nature of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a session management function (SMF) entity supporting uplink scheduling of a terminal using a tethered device, the method comprising:
receiving, from an access and mobility management function (AMF) entity, a protocol data unit (PDU) session-related session management (SM) message including at least one of a tethered device support indication and tethered device jitter information; and
in response to the PDU session-related SM message, transmitting, to an access network (AN) via the AMF entity, N2 SM information including at least one of the tethered device support indication and the tethered device jitter information.

2. The method of claim 1, further comprising:
transmitting, to a policy control function (PCF) entity, an SM policy control update request message including at least one of the tethered device support indication and the tethered device jitter information; and
in response to the SM policy control update request message, receiving a response message including an updated policy and charging control (PCC) rule,
wherein the N2 SM information further includes an updated quality of service (QOS) profile.

3. The method of claim 1, further comprising:
transmitting, to a policy control function (PCF) entity, an SM policy control update request message including uplink periodicity information, and at least one of the tethered device support indication and the tethered device jitter information; and
in response to the SM policy control update request message, receiving a response message including an updated PCC rule,
wherein the updated PCC rule includes power saving-related information.

4. The method of claim 1, wherein the N2 SM information includes a time sensitive communication assistance information (TSCAI) container based on the tethered device jitter information.

5. The method of claim 1, wherein the PDU session-related SM message is a PDUSession_CreateSMContext message or a PDUSession_UpdateSMContext message.

6. The method of claim 1, further comprising:
receiving, from the AMF entity, a message including a result value of a PDU session establishment or modification request,
wherein the result value is determined based on the N2 SM information.

7. A method of an access and mobility management function (AMF) entity supporting uplink scheduling of a terminal using a tethered device, the method comprising:
transmitting, to a session management function (SMF) entity, a protocol data unit (PDU) session-related session management (SM) message including at least one of a tethered device support indication and tethered device jitter information;
in response to the PDU session-related SM message, receiving, from the SMF entity, N2 SM information including at least one of the tethered device support indication and the tethered device jitter information; and
transmitting, to an access network (AN), the N2 SM information.

8. The method of claim 7, wherein the N2 SM information further includes an updated quality of service (QoS) profile.

9. The method of claim 7, wherein the N2 SM information includes a time sensitive communication assistance information (TSCAI) container based on the tethered device jitter information.

10. The method of claim 7, wherein, in case that an updated policy and charging control (PCC) rule supports power saving, the N2 SM information includes a time sensitive communication assistance information (TSCAI) container based on the tethered device jitter information.

11. The method of claim 7, wherein the PDU session-related SM message is a PDUSession_CreateSMContext message or a PDUSession_UpdateSMContext message.

12. The method of claim 7, further comprising:
transmitting, to the SMF entity, a message including a result value of a PDU session establishment or modification request,
wherein the result value is determined based on the N2 SM information.

13. A session management function (SMF) entity supporting uplink scheduling of a terminal using a tethered device, the SMF entity comprising:
a transceiver; and
least one processor coupled to the transceiver and configured to:
receive, from an access d ty management function entity, a protocol data unit (PDU) session-related session management (SM) message including at least one of a tethered device support indication and tethered device jitter information, and
in response to the PDU session-related SM message, transmit, to an access network (AN) via the AMF entity, N2 SM information including at least one of the tethered device support indication and the tethered device jitter information.

14. An access and mobility management function (AMF) entity supporting uplink scheduling of a terminal using a tethered device, the AMF entity comprising:
a transceiver; and
at least one processor coupled to the transceiver and configured to:
transmit, to a session management function (SMF) entity, a protocol data unit (PDU) session-related session management (SM) message including at least one of a tethered device support indication and tethered device jitter information,
in response to the PDU session-related SM message, receive, from the SMF entity, N2 SM information including at least one of the tethered device support indication and the tethered device jitter information, and
transmit, to an access network node-(AN), the N2 SM information.

15. The AMF entity of claim 14, wherein the N2 SM information further includes an updated quality of service (QOS) profile.

16. The AMF entity of claim 14, wherein the N2 SM information includes a time sensitive communication assistance information (TSCAI) container based on the tethered device jitter information.

17. The SMF entity of claim 13, the at least one processor is further configured to:
transmit, to a policy control function (PCF) entity, an SM policy control update request message including at least one of the tethered device support indication and the tethered device jitter information; and
in response to the SM policy control update request message, receive a response message including an updated PCC(policy and charging control) rule,
wherein the N2 SM information further includes an updated quality of service (QoS) profile.

18. The SMF entity of claim 13, wherein the N2 SM information includes a time sensitive communication assistance information (TSCAI) container based on the tethered device jitter information.

19. The SMF entity of claim 13, wherein the PDU session-related SM message is a PDUSession_CreateSMContext message or a PDUSession_UpdateSMContext message.

20. The SMF entity of claim 13, the at least one processor is further configured to:
receive, from the AMF entity, a message including a result value of a PDU session establishment or modification request,
wherein the result value is determined based on the N2 SM information.
